(19) United States
(12) Patent Application Publication
(10) Pub. No.: US 2022/0304333 A1
(43) Pub. Date: Sep. 29, 2022

(54) METHOD OF EXTRACTING PROTEIN FROM SEA LETTUCE

(71) Applicants: Hyeon Gyu NAM, Busan (KR); Kang Ho BAE, Busan (KR)

(72) Inventors: Hyeon Gyu NAM, Busan (KR); Kang Ho BAE, Busan (KR)

(73) Assignee: Hyeon Gyu NAM, Busan (KR)

(21) Appl. No.: 17/609,931

(22) PCT Filed: Nov. 19, 2020
(86) PCT No.: PCT/KR2020/016322

§ 371 Date: Nov. 9, 2021

(30) Foreign Application Priority Data
Aug. 28, 2020 (KR) 10-2020-0108933

(51) Int. Cl. A23J 3/20; A23K 10/30

(52) U.S. Cl. CPC A23J 3/20; A23K 10/30

(57) ABSTRACT

The present invention relates to a method for extracting proteins from sea lettuce, and more specifically to a method for preparing a sea lettuce extract with a high protein content by removing pigments, polysaccharides, etc. from sea lettuce to obtain a sludge and incubating the sludge with a microorganism of the genus Laceyella. According to the method of the present invention, a sea lettuce extract with a high protein content is prepared from sea lettuce using a microorganism of the genus Laceyella.

### TECHNICAL FIELD

The present invention relates to a method for extracting proteins from sea lettuce, and more specifically to a method for preparing a sea lettuce extract with a high protein content by removing pigments, polysaccharides, etc. from sea lettuce to obtain a sludge and incubating the sludge with a microorganism of the genus Laceyella.

### BACKGROUND ART

Sea lettuce is a seaweed belonging to the family Ulvaceae of the order Ulvales in the Chlorophyceae and is widely distributed worldwide. Examples of sea lettuce species include Ulva lactuca, Ulva pertusa, Ulva fasciata, and Ulva linza. Sea lettuce inhabits rocks and pilings in the intertidal zone which is highly affected mainly by waves.

Sea lettuce grows in large quantity from early spring to summer, produces malodor, and improperly affects the surrounding environmental ecosystem during its proliferation and deposition. Due to its outstanding ability to absorb nutritive salts, sea lettuce threatens the survival of other valuable seaweeds and coastal inhabitants. Nevertheless, the breeding rate of sea lettuce continues to increase every year, making it difficult to harvest and dispose of sea lettuce.

Ulva lactuca, a species of the genus Ulva, is consumed in the form of soup in some areas of Jeonnam province of South Korea, processed into edibles in other countries except South Korea, and seasoned or cooked in Jeju province of South Korea. However, Ulva lactuca is mostly processed into livestock feed or is discarded without further processing.

Under these circumstances, Korea Patent No. 10-0852744 is intended to provide an antibacterial feed composition for preventing diseases caused by bacteria threatening farmed fish including a sea lettuce extract. According to this patent, feeds are produced by extracting sea lettuce with ethanol, fractionating the ethanolic extract with various solvents, and concentrating the fractions. However, the sea lettuce wastes remaining after extraction need to be reprocessed or disposed of.

### DETAILED DESCRIPTION OF THE INVENTION

### Problems to be Solved by the Invention

The present invention has been made in view of the above-mentioned problems and intends to provide a method for extracting a large amount of proteins from a sea lettuce sludge remaining after extraction of active ingredients such as polysaccharides and pigments from sea lettuce.

### Means for Solving the Problems

An aspect of the present invention provides a method for extracting proteins from sea lettuce, including subjecting sea lettuce to extraction to obtain a sludge (first step), culturing a microorganism of the genus Laceyella to produce a culture broth (second step), and adding the culture broth to the sludge and incubating the mixture (third step) wherein the microorganism of the genus Laceyella degrades polysaccharides in the sludge.

The sea lettuce used in the first step contains 1 to 15% of water and is pulverized to a size of 1 to 500 mesh.

In the first step, the sea lettuce is extracted with one or more solvents selected from n-hexane, dichloromethane, butanol, acetone, ethanol, acetoacetate, methanol, and purified water.

The third step is carried out at a temperature of 30° C. to 60° C. for 24 hours to 96 hours.

### Effects of the Invention

According to the method of the present invention, a sea lettuce extract with a high protein content is prepared from sea lettuce using a microorganism of the genus Laceyella. The sea lettuce extract contains antioxidants, immune substances, and protein sources. Sea lettuce is classified as a waste resource because it decays easily, produces malodor, is aesthetically displeasing, and promotes the spread of pests in the ocean. The method of the present invention can provide a sea lettuce extract and a sea lettuce sludge that can find application in various industrial fields.

In addition, extraction from sea lettuce with solvents and recycling of the solvents proceed simultaneously, ensuring increased extraction efficiency of active ingredients. Active ingredients with different characteristics can be extracted depending on the kind of solvents used. Incubation with the microorganism of the genus Laceyella leads to an increase in the protein content of the sea lettuce sludge, achieving a high protein content of the extract.

Furthermore, proteins extracted from sea lettuce by the method of the present invention can be used as protein sources in foods and feeds for ocean organisms. Particularly, the sea lettuce proteins can replace fishmeal that causes many problems, including overfishing of fishery resources, economic inefficiency, and deterioration of the marine environment.

### BRIEF DESCRIPTION OF THE DRAWINGS

FIG. 1 is a process flow diagram in an extraction system for preparing a sea lettuce extract used in a method according to one embodiment of the present invention.

FIG. 2 is a growth curve of Laceyella sacchari used in a method according to one embodiment of the present invention.

FIG. 3 shows the ability of Laceyella sacchari used in a method according to one embodiment of the present invention to degrade cellulose.

FIG. 4 shows the ability of Laceyella sacchari used in a method according to one embodiment of the present invention to degrade kelp fronds.

### MODE FOR CARRYING OUT THE INVENTION

Throughout the present specification, when a certain part “comprises” or includes” a certain component, this implies the inclusion of any other component but not the exclusion of any other component, unless indicated to the contrary.

The present invention will now be described in more detail.

The present invention is directed to a method for extracting proteins from sea lettuce, and more specifically to a method for preparing a sea lettuce extract with a high protein content by removing pigments, polysaccharides, etc. from sea lettuce to obtain a sludge and incubating the sludge with a microorganism of the genus Laceyella.

According to one aspect of the present invention, a method for extracting proteins from sea lettuce includes subjecting sea lettuce to extraction to obtain a sludge (first step), culturing a microorganism of the genus Laceyella to produce a culture broth (second step), and adding the culture broth to the sludge and incubating the mixture (third step) wherein the microorganism of the genus Laceyella degrades polysaccharides in the sludge.

In the method of the present invention, the proteins may be extracted from raw sea lettuce or dried sea lettuce. Alternatively, the proteins may be ones present in a residue (that is, the sludge) remaining after extraction from raw sea lettuce or dried sea lettuce. In the first step, sea lettuce is subjected to extraction to obtain a sludge. The sea lettuce used in the first step contains 1 to 15% of water. The sea lettuce may be repeatedly washed with water to remove foreign matter and salt components before use. Preferably, the sea lettuce is dehydrated with a press machine to remove a portion of the water after washing. More preferably, the dehydrated sea lettuce is dried with hot air. At this time, the water content of the sea lettuce is adjusted to 1 to 15%, preferably 2 to 7%.

The first step may include pulverizing the sea lettuce to a size of 1 to 500 mesh. The pulverization is performed to extract the sea lettuce more efficiently and the degree of pulverization is adjusted such that an effective extraction yield is maintained. The sea lettuce is pulverized to a size of 1 to 500 mesh, preferably 1 to 400 mesh, more preferably 3 to 230 mesh. If the size of the pulverized sea lettuce pieces is outside the range of 1 to 500 mesh, the excessively fine sea lettuce pieces may lead to low extraction efficiency or the narrow distance between the sea lettuce pieces may lead to a small contact area with solvents, resulting in a reduction in extraction efficiency.

The first step may employ a continuous extraction process using one or more solvents. According to a conventional extraction process, active ingredients are extracted from a solute (a material to be extracted) based on an outflow phenomenon caused by a difference in concentration between a solvent and the solute and process parameters such as temperature, pressure, and time are controlled to shorten the time when the concentrations between the solvent and the solute match, that is, the extraction time of active ingredients.

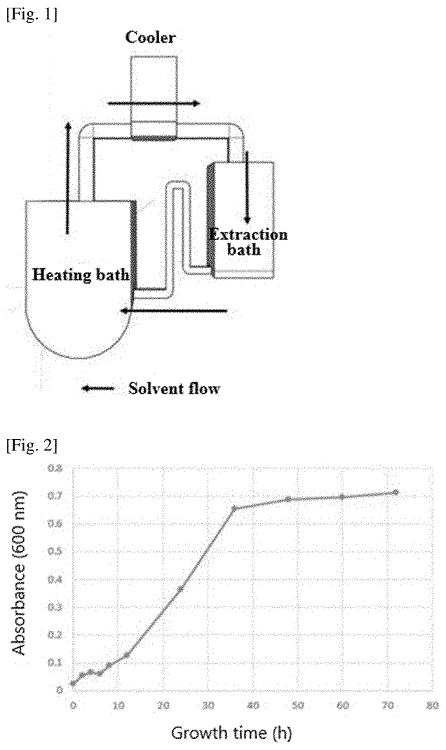

In contrast, the method of the present invention employs a syphon chain reaction extraction process (SCREP) based on the syphon principle to simultaneously perform solute extraction with solvents and recycling of the solvents. FIG. 1 is a flow diagram of the syphon chain reaction extraction process employed in the present invention. More specifically, the syphon chain reaction extraction process can be carried out by the following procedure. First, sea lettuce is extracted with solvents in an extraction bath. The solvents containing the extracted active ingredients are moved to a heating bath by the syphon principle and the moved solvents are vaporized by heating. The solvent vapors are then cooled for liquefaction into their pure solvent states, which are sent back to the extraction bath. This recycling allows repeated extraction from the sea lettuce. At this time, active ingredients present in the solvents settle down at the bottom of the heating bath and are separated from the vaporized solvents. This series of processes is repeated. As a result, the solvents containing the active ingredients are moved to the heating bath, and at the same time, the pure solvents vaporized in the heating bath are fed back to the extraction bath. Therefore, active ingredients can be continuously extracted from the sea lettuce with predetermined amounts of the solvents in one extraction system.

The syphon chain reaction extraction process enables continuous and repeated extraction because extraction solvents can be returned to their pure states by recycling despite high contents of active ingredients in the solvents. In contrast, according to a conventional extraction process, no significant extraction of active ingredients from a solute with an extraction solvent occurs despite precise control over process parameters (for example, temperature, pressure, and time).

In the first step employing this syphon chain reaction extraction process, active ingredients can be extracted from sea lettuce with one or more solvents selected from n-hexane, dichloromethane, butanol, acetone, ethanol, acetoacetate, methanol, and purified water. When it intends to use the extracted active ingredients in a food or feed composition, one or more solvents selected from n-hexane, acetone, ethanol, and purified water are preferably used to extract sea lettuce.

In the second step, a microorganism of the genus Laceyella is cultured to produce a culture broth. The second step may include isolating the microorganism of the genus Laceyella from the intestine of abalone. The microorganism of the genus Laceyella is preferably Laceyella sacchari isolated from the intestine of abalone.

Marine broth (MB) medium may be used to culture the microorganism of the genus Laceyella. MB media are usually used to culture marine-derived microorganisms. MB media are optimized for the growth of suspended marine microorganisms. MB media are industrially very useful because they contain essential nutritive salts for the growth of microorganisms, but their production involves considerable costs, making it difficult to apply them to industrial fields. Thus, the method of the present invention may use a medium containing one or more components selected from NaCl, egg yolk, milk, yeast extract, defatted soybean meal, barley, brown rice, and oat, as well as MB medium. The microorganism of the genus Laceyella can grow in an environment where sufficient amounts of nutritive salts such as Na, K, Ca, P, and Fe are present. Since the growth of the microorganism of the genus Laceyella requires specific amounts of proteins and carbohydrates, the microorganism of the genus Laceyella can be cultured in a medium containing effective amounts of proteins and carbohydrates and one or more components selected from egg yolk, milk, yeast extract, defatted soybean meal, barley, brown rice, and oat.

In the second step, the microorganism is preferably cultured at a temperature of 25° C. to 55° C., a salinity of 0.1% to 1.5%, and a pH of 4.0 to 9.0 for 12 hours to 60 hours, more preferably at a temperature of 35° C. to 55° C., a salinity of 0.2% to 0.9%, and a pH of 5.5 to 8.0 for 24 hours to 40 hours.

If the culture time is outside the range of 12 hours to 60 hours, the microorganism does not grow well, making it impossible to significantly degrade polysaccharides present in the sea lettuce. If the culture temperature is outside the range of 25° C. to 55° C. and the salinity is outside the range of 0.1% to 1.5%, the microorganism does not grow well or slowly. If the pH is outside the range of 4.0 to 9.0, the microorganism may not grow at all.

In the third step, the culture broth is added to the sludge and the mixture is incubated. The sea lettuce sludge used in the third step may be a residue remaining after extraction from the raw sea lettuce or dried sea lettuce with water or an organic solvent. Alternatively, the sea lettuce sludge may be the raw sea lettuce or dried sea lettuce per se. Alternatively, the sea lettuce sludge may be a sea lettuce extract obtained by concentration, solvent removal, drying, and solidification after extraction.

In the third step, the sea lettuce sludge and the culture broth may be incubated at a temperature of 30° C. to 60° C., preferably 35° C. to 55° C. If the incubation temperature is outside the range of 30° C. to 60° C., the activity of the microorganism in the culture broth deteriorates, with the result that the incubation with the sea lettuce sludge does not proceed well, making it impossible to remove or degrade polysaccharides present in the sea lettuce sludge.

In the third step, the incubation time is from 24 hours to 96 hours, preferably 48 hours to 96 hours. If the incubation time is less than 24 hours, the incubation does not occur sufficiently, with the result that polysaccharides present in the sea lettuce sludge cannot be removed or degraded sufficiently and the content of proteins in the sludge cannot increase significantly. Meanwhile, if the incubation time exceeds 96 hours, the content of proteins in the sludge increases further but may not increase significantly with increasing incubation time.

In the third step, the weight ratio between the sea lettuce sludge and the culture broth of the microorganism is 99:1 to 17:3, preferably 19:1 to 9:1. If the weight ratio between the sea lettuce sludge and the culture broth is outside the range of 99:1 to 17:3, the amount of the microorganism is not sufficient to degrade polysaccharides and cellulose present in the sludge or the content of proteins in the sludge increases but the use of the large amount of the culture broth is inappropriate for industrial use.

The third step of the method according to the present invention can be called a bio-conversion process. A conventional bio-conversion process is one of the methods that directly use enzymes to produce active ingredients. The bio-conversion process employed in the method of the present invention uses a microorganism rather than an enzyme to degrade polysaccharides. The use of a microorganism reduces the production cost of protein sources derived from sea lettuce and the cost required to create an environment to induce enzymatic activity. In addition, a microorganism can be cultured for its continuous use. Therefore, the use of a microorganism leading to a much higher protein yield than the use of an enzyme.

Hereinafter, the present invention will be described in detail with reference to exemplary embodiments. However, these embodiments may be changed into several other forms and the scope of the present invention should not be construed as being limited to the following embodiments. The embodiments of the present invention are intended to more comprehensively explain the present invention to those skilled in the art.

### Examples

### Example 1—Pulverization of Sea Lettuce

Raw sea lettuce was washed repeatedly with water to remove salt and foreign matter and was partially dehydrated with a press machine. The dehydrated sea lettuce was dried in a hot air dryer for 10 h. The drying temperature was set to 80° C.

The water content of the dried sea lettuce was ˜2.4% and increased up to 8% depending on external humidity. The dried sea lettuce was once processed with a roll mill, pulverized to different sizes of 3.5 mesh, 5 mesh, 10 mesh, 20 mesh, 40 mesh, 80 mesh, 120 mesh, 200 mesh, and 230 mesh by reprocessing with a pin mill, extracted, and dried. The unpulverized raw sea lettuce and the dried extracts were weighed to determine an optimal extraction yield.

### Example 2—Extraction from Sea Lettuce (by Syphon Chain Reaction Extraction Process; SCREP)

An extraction system consisting of an extraction bath, a heating bath, and a cooling bath was used to prepare a sea lettuce extract by a syphon chain reaction extraction process based on the syphon principle. After extraction solvents were filled up to 30% of the volume of the extraction bath, the dried sea lettuce pieces prepared in Example 1 were added in an amount corresponding to half of the volume of the extraction solvents. At this time, an extraction cloth having a mesh size larger than that of the pulverized sea lettuce was used in the extraction bath. The sea lettuce was extracted in the heating bath at a temperature set to 70° C. and a pressure set to −0.5 atm for 1-4 h. At this time, an organic solvent was used to extract pigments from the sea lettuce. After recovery of the extracted pigments, purified water was added to extract polysaccharides from the sea lettuce. Sea lettuce-derived proteins were extracted from sea lettuce sludge left after extraction of the pigments and polysaccharides.

The continuous extraction process employed in the present invention enables recycling and reuse of the solvents, eliminating the need to additionally add new extraction solvents. In addition, the initially added solvents undergo continuous and repeated extraction-recycling-extraction cycles, enabling effective extraction of active ingredients from the solute. After extraction of active ingredients from the solute with the solvents, active ingredients are separated from the solvents and the solvents are vaporized by heating and liquefied into their pure states, which are sent back to the extraction bath. This series of processes enables continuous extraction of active ingredients from the solute.

### Example 3—Isolation and Culture of Microorganism of the Genus Laceyella

Laceyella sacchari, a microorganism of the genus Laceyella, was used to extract proteins from sea lettuce. The microorganism was isolated from abalone intestine.

A predetermined amount of the green part of the intestine of abalone purchased from the National Federation of Fisheries Cooperatives, Wando, Jeonnam province of South Korea was collected, mixed with purified water, and crushed with a sterilized mixer. The mixture was allowed to stand for 10 min. The supernatant was collected and a bacterial strain was isolated from the abalone intestine. The isolated bacterial strain was cultured in marine broth (MB) or a home-made medium before use.

### Example 4—Incubation of the Sea Lettuce with the Culture Broth (by Bio-Conversion Process)

The sea lettuce sludge left after extraction of the pigments and polysaccharides in Example 2 was mixed with the microorganism Laceyella sacchari isolated and cultured in Example 3. The mixture was incubated with stirring. More specifically, the microorganism Laceyella sacchari was cultured in a home-made selective medium at 35° C. for 24-40 h before use. The sea lettuce sludge from which pigments and polysaccharides had been removed was recovered from the extraction bath, pressed using a press machine, dehydrated, and weighed. The dried sludge was mixed with the Laceyella sacchari culture broth at a temperature of 35-55° C. with stirring at a rate of 300-500 rpm. The culture broth was used in an amount corresponding to 1-15 wt % of the dried sludge. The incubation was performed under aerobic conditions for 24-96 h to degrade cellulose in the sea lettuce.

### Comparative Example 1—Extraction from Sea Lettuce

100 g of dried sea lettuce was put into an extraction system and 100% ethanol or distilled water was added thereto. The mixture was heated at 70° C. under near-vacuum conditions (−0.5 atm) for 30 min to prepare a sea lettuce extract. The extract was separated by paper filtration and concentrated under vacuum to remove the solvent. The concentrate was placed in an aluminum dish spread with sea sand and dried again by heating at 105° C. for 4 h. The redried sea lettuce concentrate was weighed to determine a final extraction yield.

### EXPERIMENTAL EXAMPLES

### Experimental Example 1—Determination of Extraction Yields

100 g of each of the sea lettuce powders having different sizes prepared in Example 1 was put into the extraction system and extracted by SCREP at 70° C. under near-vacuum conditions (−0.5 atm) for 30 min. The resulting extract was separated by paper filtration and concentrated under vacuum to remove the solvents. The concentrate was placed in an aluminum dish spread with sea sand and dried again by heating at 105° C. for 4 h. The redried sea lettuce concentrate was weighed to determine a final extraction yield.

### Experimental Example 2—Measurement of Protein Contents

The protein content of the finally extracted sea lettuce sludge was measured to determine the protein yield of the extracted sea lettuce.

The presence of nitrogen (N) as a specific protein component was determined to infer the content of proteins by the Kjeldahl method for crude protein measurement. The degradation of the protein sample with sulfuric acid (H₂SO₄) produced (NH₄)₂SO₄, which was allowed to react with NaOH to produce NH₃. The produced vapor was captured and cooled in a container containing HBO₃ to change the pH. Thereafter, neutralization with dilute sulfuric acid was conducted. The point at which the pH value was returned to its initial value was taken as EP at which the nitrogen content was measured. The sample was placed in a flask dedicated to proteolysis and one tablet of a proteolytic agent (K₂SO₄ 5 g+ 1/10 g CuSO₄.5H₂O) was added thereto. Then, 10 ml of sulfuric acid was added to the protein digestion reactor and the reaction was carried out under heating at 30° C. for 2 h with a maximum of 80% power. The protein content was measured with a protein analyzer.

### Experimental Example 3-1—Antioxidant Activity Test (DPPH)

2,2-Diphenyl-1-picrylhydrazyl (DPPH) was used to investigate the antioxidant activity of the proteins extracted in Example 2. DPPH causes a color change from purple to yellow when a free electron (radical) of the N-group and a free electron of —R form a shared pair of electrons. This color change indicates the scavenging of a radical in a specific substance, which is also expressed as an electron donating ability because the electron in DPPH is donated to the radical of —R.

7.88 mg of 0.2 mM DPPH reagent was dissolved in 100 ml of methanol to prepare a test reagent. Ascorbic acid was used as a standard. 0.1 ml of the DPPH test reagent was dispensed in 0.1 ml of the sea lettuce extract sample. The reaction was allowed to proceed at 37° C. for 30 min. The standard was diluted to different concentrations (1-50 μg/ml) and was allowed to react with 0.1 ml of the sea lettuce extract sample in the same manner as described above. Then, the absorbance was measured at a wavelength of 540 nm to determine the antioxidant activity of the proteins.

### Experimental Example 3-2—Antioxidant Activity Test (ABTS)

2,2′-Azino-bis(3-ethylbenzothiazoline-6-sulfonic acid) (ABTS) was used to investigate the antioxidant activity of the proteins extracted in Example 2. ABTS is a substance that reacts with potassium persulfate to make a dark green product, which is then decolorized by an antioxidant. Based on this principle, ABTS can be used to verify antioxidant activity.

7 mM ABTS was dissolved to a concentration of 0.384 g/100 ml in diammonium salt to prepare a test reagent. 2.45 mM potassium persulfate was dissolved to a concentration of 0.066 g/100 ml in distilled water. The two reagents thus prepared were mixed in a ratio of 1:1 and left in the dark for one day to prepare an ABTS radical solution. Ascorbic acid (10-100 μg/ml) was used as a standard as in Experimental Example 3-1. After the ABTS radical solution was mixed with distilled water in a 1:1 ratio, different concentrations of the sea lettuce sample (each 0.5 ml) were dispensed into e-tubes and 0.5 ml of the ABTS radical solution was dispensed into each e-tube. The sea lettuce sample and the ABTS radical solution were mixed in the e-tubes.

The standard was tested in the same manner as described above Immediately after dispensing the ABTS radical solution, the absorbance was measured at a wavelength of 734 nm to verify antioxidant activity.

### Experimental Example 4—Determination of Microbial Homology

In this example, the microorganism isolated in Example 3 was identified. First, the microorganism was cultured and proliferated in MB medium for a predetermined period of time. Then, 16sRNA analysis was requested. The biochemical properties of the microorganism were analyzed using an API kit. The microorganism was found to have the ability to degrade cellulose (see Experimental Example 7). After the microorganisms were grown in MB medium, the absorbance was measured at a wavelength of 600 nm using a UV-VIS spectrophotometer. The microorganism was tested when its OD value was ≥0.5. The bacterial solutions (each 200 μl) with appropriate OD values were dispensed into cuvettes of the API kit, mixed by pipetting, and cultured at 35° C. for 2 days. The biochemical properties of the strain were confirmed by a color change.

### Experimental Example 5—Determination of Growth of the Microorganism in Different Culture Media

In this example, an optimal culture medium for the microorganism isolated in Example 3 was prepared. To this end, media were prepared that contained Na, K, Ca, P, and Fe, which are common nutritive salts used in conventional MB media, and natural ingredients, including egg yolk powder, milk, yeast extract, defatted soybean meal, barley, brown rice, and oat, which include predetermined amounts of proteins and carbohydrates.

The natural ingredients whose contents were set in percent (%) were added to 1 L of purified water, sterilized in an autoclave for 20 min, and allowed to cool to 35° C. Then, 10 ml of Laceyella sacchari diluted to a concentration of 1×10⁶ was dispensed into each medium. After culture at 35° C. for 4 days, the absorbance was measured at a wavelength of 600 nm. After the bacterial strain was inoculated into an MB agar plate, the number of colonies in the agar plate was measured. For comparison, the bacterial strain was plated onto MB medium whose concentration was adjusted to 37.4 g/L and cultured under the same conditions. The absorbance and the number of colonies in the MB medium were measured and compared with those measured in the nutrient medium to determine the degree of growth of the bacteria.

### Experimental Example 6—Determination of Growth of the Microorganism Under Different Conditions

In this example, optimal conditions for the growth of Laceyella sacchari isolated in Example 3 were determined. To this end, temperature, salinity, and pH conditions were set to 25-55° C., 0.5%-3.0%, and 4.5-9.5, respectively. The bacteria were cultured under the set conditions to determine optimal temperature, salinity, and pH conditions. A culture time suitable for the growth of Laceyella sacchari was determined. To this end, the bacteria were inoculated into media and cultured for 72 h. The absorbance values were measured at different times to plot a growth curve.

### Experimental Example 7—Determination of Ability of Laceyella sacchari to Degrade Cellulose

The ability of the strain isolated from abalone intestine in Example 3 to degrade cellulose was determined using MB medium and carboxymethylcellulose (CMC).

Abalone intestines were collected, mixed, and pulverized. The supernatant was collected and spread on an MB agar plate containing 0.1% CMC. The spread plate was incubated in an incubator at a temperature of 35° C. for 4 days. On the fourth day, 0.5 ml of iodine reagent was dispensed for reaction with CMC. Thereafter, whether the cellulose was degraded was determined by a color change. CMC tends to turn purple in color upon reaction with iodine. However, when CMC is absent in a plate as a result of degradation by a microorganism, no color change occurs.

### Experimental Example 8—Determination of Ability of Laceyella sacchari to Degrade Kelp Fronds

50 ml of the bacterial culture broth and 10 g of raw kelp fronds (size=1 cm (w)×3 cm (1)) were placed in 200 mL of MB medium. After sufficient mixing, the degree of degradation of the kelp fronds was determined by visual observation during culture at 35° C. for 96 h with stirring at 250 rpm in a stirred incubator. For comparison, the above procedure was repeated except that the bacterial culture broth was not added.

<Results and Evaluation>

Result 1—Extraction Yields According to Sizes of the Pulverized Sea Lettuce

The extraction efficiencies according to the sizes of the sea lettuce pulverized in Example 1 were determined in Experimental Example 1. The results are shown in Table 1.

TABLE 1

| Mesh size | Final dry weight (g) |
|---|---|
| Raw sea lettuce | 0.45 |
| 3.5 | 0.58 |
| 5 | 0.63 |
| 10 | 0.71 |
| 20 | 0.75 |
| 40 | 0.65 |
| 80 | 0.67 |
| 120 | 0.59 |
| 200 | 0.55 |
| 230 | 0.47 |

As a result, the final dry weight of the extract from the unpulverized raw sea lettuce was 0.45 g. The final dry weight of the extract from the sea lettuce pulverized to a size of 20 mesh was the largest (0.75 g). The final dry weight of the extract from the sea lettuce pulverized to a size of 120 mesh, which is similar to that of wheat flour, was 0.59 g. The final dry weight of the extract from the sea lettuce pulverized to a size of 230 mesh was greater than that of the extract from the raw sea lettuce. That is, the extraction yield from the sea lettuce pulverized to a size of 230 mesh was higher than that from the raw sea lettuce.

Result 2-1—Extraction Yields of Pigments and Polysaccharides from the Sea Lettuce

The extraction yields of pigments and polysaccharides from the sea lettuce by a continuous extraction process in Example 2 were determined. The results are shown in Table 2.

TABLE 2

| | Final extraction yield (%) | | |
|---|---|---|---|
| | Heat extraction | SCREP extraction | Remark |
| Pigments | 7.24 ± 0.28 | 19.58 ± 0.41 | 270% increase |
| Polysaccharides | 13.58 ± 0.25 | 17.23 ± 0.36 | 126% increase |

The extraction yield of pigments from the sea lettuce with 100% ethanol as a solvent and the extraction yield of polysaccharides with distilled water as a solvent by a general heating extraction process in Comparative Example 1 were compared with those of pigments and polysaccharides by SCREP in Example 2. As a result, the extraction yield was increased by a maximum of 270%.

Result 2-2—Measurement of Protein Contents of the Sea Lettuce

The protein content of the sea lettuce sludge remaining after extraction of pigments and polysaccharides in Example 2 was measured in Experimental Example 2 and compared with that of the dried sea lettuce.

As a result, the protein content of the dry sea lettuce was ˜27%, whereas the protein content of the sea lettuce sludge was ˜34-39%. Despite the presence of cellulose structures, minerals, polysaccharides, and pigments other than proteins in sea lettuce, a higher protein content was found in the sea lettuce sludge because the components other than proteins were removed when pigments and polysaccharides were partially extracted and removed by the extraction process.

Result 2-3—Comparison of Amounts of Pigments Extracted from the Sea Lettuce

The amount of pigments extracted from the sea lettuce by a syphon chain reaction extraction process in Example 2 was compared with that of pigments extracted from the sea lettuce by a conventional extraction process in Comparative Example 1 to determine the extraction yield.

As a result, 7.24 g of pigments were extracted from 100 g of the dried sea lettuce in Comparative Example 1, while 19.58 g of pigments were extracted from 100 g of the dried sea lettuce in Example 2, indicating a ˜270% increase in extraction yield.

Result 2-4—Comparison of Antioxidant Activities of the Sea Lettuce Extracts (Pigments)

The antioxidant activities of pigments extracted from the sea lettuce in Example 2 were measured in Experimental Examples 3-1 and 3-2 and compared with those of pigments extracted from the sea lettuce in Comparative Example 1. The results are shown in Table 3.

TABLE 3

| | Comparative | | Increase or decrease |
|---|---|---|---|
| | Example 1 | Example 2 | in efficiency |
| DPPH method | 85.14% | 95.36% | 112% increase |
| ABTS method | 79.93% | 92.25% | 115% increase |
| Total content of | 0.244 mg/g | 0.547 mg/g | 224% increase |
| phenolic components | Eq. caffeic | Eq. caffeic | |
| | acid | acid | |

As can be seen from the results in Table 3, the antioxidant activities of pigments extracted from the sea lettuce in Example 2 were higher, as determined by both antioxidant activity tests using DPPH and ABTS. In addition, the total content of phenolic components was also increased by ˜224%, indicating the presence of large amounts of active ingredients.

Result 3—Determination of Microbial Homology

The microorganism isolated from abalone intestine in Example 3 was identified by a microbial homology test in Experimental Example 4.

As a result, the isolated microorganism was identified as Laceyella sacchari from its biochemical properties analyzed using an API kit. The results of 16sRNA analysis revealed that the homology was 99.8%, which also demonstrated that the microorganism isolated from abalone intestine was Laceyella sacchari that is active in cellulose degradation.

Result 4-1—Determination of Growth of the Microorganism in Different Culture Media

Media containing various natural ingredients for the growth of the microorganism isolated in Example 3 were prepared and the degrees of growth of the bacteria were determined in Experimental Example 5. The results are shown in Table 4.

TABLE 4

| | | | Yeast | Defatted | | | | Egg yolk + |
|---|---|---|---|---|---|---|---|---|
| Content | Egg yolk | Milk | extract | soybean meal | Barley | Brown rice | Oat | barley |
| 1% | +++ | ++ | +++ | − | ++ | ++ | ++ | +++ |
| 2% | ++++ | +++ | ++++ | − | ++ | ++ | ++ | ++++ |
| 3% | ++++ | +++ | +++ | − | +++ | +++ | +++ | ++++ |
| 5% | ++ | ++ | ++ | − | +++ | +++ | +++ | +++ |
| 8% | ++ | ++ | − | − | +++ | +++ | +++ | +++ |
| 10% | − | + | − | − | +++ | +++ | +++ | + |

In Table 4, a larger number of the plus signs (+) indicates better growth of the bacteria in the corresponding medium. The minus sign (−) means no growth of the bacteria. From these results, conditions for a culture broth as a replacement for marine broth were set to 1-5% egg yolk, 1-3% barley, 0.5-2.5% NaCl, and 1-5% yeast extract.

Result 4-2—Determination of Growth of the Microorganism Under Different Conditions

Optimal growth conditions for culturing the microorganism isolated in Example 3 were determined in Experimental Example 6.

A growth curve was plotted to determine an optimal culture time of the microorganism. The results are shown in FIG. 2. As a result, Laceyella sacchari started to grow rapidly from 12 h after culture and continued to grow until 36 h, and its growth was maintained constant from 48 h.

Laceyella sacchari was cultured under different temperature, salinity, and pH conditions to determine optimal conditions for the growth of the microorganism. The results are shown in Table 5.

TABLE 5

| | Value | Growth response |
|---|---|---|
| Temperature | 25° C. | +++ |
| | 30° C. | +++ |
| | 35° C. | +++ |
| | 40° C. | +++ |
| | 45° C. | +++ |
| | 50° C. | ++++ |
| | 55° C. | +++++ |
| Salinity | 0.5% | +++++ |
| | 0.7% | +++++ |
| | 1.0% | +++ |
| | 1.2% | ++ |
| | 1.5% | + |
| | 2.0% | − |
| | 2.5% | − |
| | 3.0% | − |
| pH | 4.5 | + |
| | 5.0 | + |
| | 5.5 | ++ |
| | 6.0 | +++ |
| | 8.0 | ++ |
| | 8.5 | + |
| | 9.0 | + |
| | 9.5 | − |

In Table 5, a larger number of the plus signs (+) indicates better growth of the bacteria. The minus sign (−) means no growth of the bacteria. The culture media were all MB media. The salinity was adjusted by addition of NaCl to the MB medium. In conclusion, optimal culture conditions for Laceyella sacchari were a temperature of 35-55° C., a salinity of 0.2%-0.9%, and a pH of 5.5-8.0.

Results 5—Ability of Laceyella sacchari to Degrade Cellulose

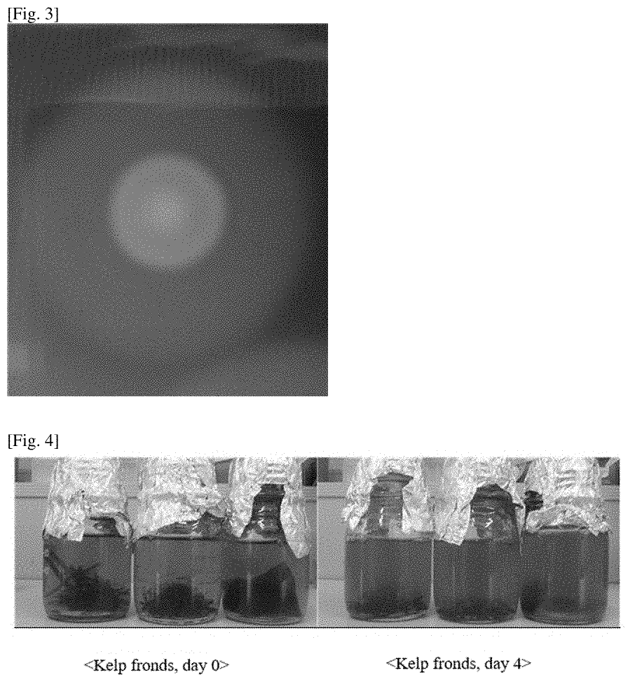

The ability of the strain isolated in Example 3 to degrade cellulose was determined in Experimental Example 7. The results are shown in FIG. 3.

Iodine was allowed to react with CMC in the MB agar plate on which the microorganism was cultured. As a result of the reaction, no significant color change was observed, demonstrating that cellulose was degraded by the microorganism isolated from abalone intestine. After that, colonies of the microorganism were collected with platinum ear and cultured in MB medium. The microorganism was identified as Laceyella sacchari.

Laceyella sacchari was plated and cultured on a paper disk placed on an MB agar plate containing CMC. The results are shown in FIG. 3. Referring to FIG. 3, a clear ring was formed outside the paper disk. This was explained by the activity of cellulase secreted from Laceyella sacchari for CMC degradation.

Result 6—Degradation of kelp fronds by Laceyella sacchari

The ability of Laceyella sacchari to degrade kelp fronds was determined in Experimental Example 8. The results are shown in FIG. 4. After incubation with Laceyella sacchari, the kelp fronds were visually observed. As a result, the circumferential edges of the kelp fronds were degraded and the fronds fell apart, demonstrating that cellulose in the kelp fronds was degraded by Laceyella sacchari. These results concluded that the Laceyella sacchari strain has the ability to effectively degrade cellulose.

Result 7—Measurement of Contents of Proteins Extracted from the Sea Lettuce by Syphon Chain Reaction Extraction Process and Bio-Conversion Process

The contents of proteins extracted from the sea lettuce in Examples 1-4 were measured in Experimental Example 2. The results are shown in Table 6.

TABLE 6

| Amount of | | | | | | |
|---|---|---|---|---|---|---|
| Laceyella | | | | | | |
| sacchari | Time (h) | | | | | |
| plated (%) | 24 | 36 | 48 | 60 | 72 | 96 |
| 1 | 34.50% | 34.68% | 34.25% | 36.22% | 37.54% | 38.22% |
| 3 | 34.45% | 34.58% | 35.58% | 37.42% | 38.69% | 39.15% |
| 5 | 34.58% | 34.68% | 36.28% | 37.81% | 38.96% | 40.25% |
| 7 | 35.02% | 35.25% | 36.59% | 38.11% | 40.12% | 41.58% |
| 10 | 35.21% | 35.41% | 37.54% | 38.89% | 41.29% | 43.21% |
| 15 | 35.74% | 35.98% | 36.57% | 38.69% | 41.57% | 44.21% |

As can be seen from the results in Table 6, the content of proteins in the sea lettuce sludge extracted in Example 2 was 34.65%, while the content of proteins in the sea lettuce increased up to 44.21% with increasing amount of Laceyella sacchari plated and increasing incubation time. These results are explained by the ability of Laceyella sacchari to degrade cellulose and more effective extraction of proteins from the sea lettuce when the syphon chain reaction extraction process and the bio-conversion process were carried out simultaneously.

1. A method for extracting proteins from sea lettuce, comprising subjecting sea lettuce to extraction to obtain a sludge (first step), culturing a microorganism of the genus Laceyella to produce a culture broth (second step), and adding the culture broth to the sludge and incubating the mixture (third step) wherein the microorganism of the genus Laceyella degrades polysaccharides in the sludge.

2. The method according to claim 1, wherein the sea lettuce used in the first step contains 1 to 15% of water.

3. The method according to claim 1, wherein the sea lettuce used in the first step is pulverized to a size of 1 to 500 mesh.

4. The method according to claim 1, wherein, in the first step, the sea lettuce is extracted with one or more solvents selected from n-hexane, dichloromethane, butanol, acetone, ethanol, acetoacetate, methanol, and purified water.

5. The method according to claim 1, wherein the third step is carried out at a temperature of 30° C. to 60° C.

6. The method according to claim 1, wherein the third step is carried out for 24 hours to 96 hours.
